(19) United States
(12) Patent Application Publication
(10) Pub. No.: US 2009/0225392 A1
(43) Pub. Date: Sep. 10, 2009

(54) Optical Modulator and Method of Providing the Same

(76) Inventors: Christopher Michael DePriest, Tavares, FL (US); Gary Dean Ross, Longwood, FL (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/045,513

(22) Filed: Mar. 10, 2008

(51) Int. Cl. G02F 1/03

(52) U.S. Cl. 359/245

(57) ABSTRACT

An optical modulator comprises a Q-switch comprising a first pyroelectric crystal having opposing end faces disposed along a first pyroelectric axis, and a charge dissipating device comprising a second pyroelectric crystal having opposing end faces disposed along a second pyroelectric axis. The charge dissipating device is configured to provide pyroelectric charge from the opposing end faces of the second pyroelectric crystal to neutralize pyroelectric charge on opposing end faces of the first pyroelectric crystal.

### TECHNICAL FIELD

The present invention relates generally to optics, and more particularly to an optical modulator and a method of providing the same.

### BACKGROUND

A pyroelectric crystal is a crystal that experiences a pyroelectric effect due to changes in temperature. The pyroelectric effect changes the net dipole moment peer unit volume (i.e., the polarization ) of a pyroelectric material as temperature changes. The dipole moment of the unit cell is changed by thermally exciting the main donar atom in each unit cell to spatially displace itself relative to other atoms. The net result is a change in the bound surface charge along a particular crystal axis. In a pyroelectric crystal this is referred to as the pyroelectric axis, which is along the same path as the propagation path of a laser beam when the pyroelectric crystal is employed, for example, as a Q-switch optical modulator. The charge buildup on opposing end faces of the pyroelectric crystal along the pyroelectric axis builds up opposite polarity charges based on increases and/or decreases in temperature. The surface charge on the respective opposing faces can be neutralized by binding surface charge of opposite polarity to each respective opposing face employing a charge dissipating device. The charge dissipation should be done fairly uniformly over the faces of pyroelectric crystal so as to neutralize the internal field gradients within the pyroelectric crystal.

Q-switched laser systems typically need to operate over large temperature ranges, in spite of the fact that the electro-optical material of choice, lithium niobate, is highly pyroelectric. Significant temperature excursions with a pyroelectric Q-switch configuration typically lead to a loss in cavity holdoff performance, which is a condition known throughout the laser industry as “prelasing”. Because the pyroelectric effect is caused by a change in bulk polarization of the electro-optic material, the means of neutralizing it quickly is by covering the dielectric surface with a sufficient amount of (opposite) free charge. In the past, the most effective way of accomplishing this has been to use a radioactive substance to emit alpha particles, which then serve to ionize the air surrounding the lithium niobate crystal. The ionized air then serves as a constant source of both positive and negative airborne charges for the polarized dielectric surfaces to attract for neutralization. The use of radioactive materials, however, has fallen out of favor in the user community due to the licensing issues associated with the use of radioactive materials, the amount of paperwork, monitoring and disposal issues that follows products which contain radioactive materials.

There are currently several other proposed methods for neutralizing pyroelectric charge in the quest for prelaser suppression without the use of radioactive materials. All of these methods rely on the transfer of free charge onto the pyroelectric surfaces of the dielectric, which provides a means to neutralize the excess static charge resulting from any temperature change. Various sources of this free charge have been proposed, including high-voltage proximity electrodes, optically-transparent conductive coatings, and mechanically active conductive wipers. High-voltage needle electrodes placed within the proximity of the pyroelectric surface may accomplish the task of ionizing the surrounding air, but require an electrical driver. Mechanical systems have general difficulty of meeting many performance requirements and conditions associated with laser systems. An optically-transparent conductive coating laid over the pyroelectric surface would effectively neutralize the static charge, but the absorptive properties intrinsic to these conductors provide a cavity loss mechanism which can easily damage such coatings at higher optical power levels.

### SUMMARY

In one aspect of the invention, an optical modulator is provided. The optical modulator comprises a Q-switch comprising a first pyroelectric crystal having opposing end faces disposed along a first pyroelectric axis, and a charge dissipating device comprising a second pyroelectric crystal having opposing end faces disposed along a second pyroelectric axis. The charge dissipating device is configured to provide pyroelectric charge from the opposing end faces of the second pyroelectric crystal to neutralize pyroelectric charge on opposing end faces of the first pyroelectric crystal.

In yet another aspect of the invention, an optical modulator is provided. The optical modulator comprises a Q-switch comprising a first pyroelectric crystal having opposing end faces disposed along a first pyroelectric axis, and a second pyroelectric crystal having opposing end faces with conductive surfaces disposed along a second pyroelectric axis that is orthogonal to the first pyroelectric axis. The optical modulator further comprises conductors extending from conductive surfaces of each end of each opposing end face of the second pyroelectric crystal in proximity of each end face of the first pyroelectric crystal, such that pryoelectric charge of both positive and negative polarity from the second pyroelectric crystal are provided in proximity of each opposing end face of the first pyroelectric crystal.

In yet a further aspect of the invention, a method is provided for providing an optical modulator. The method comprises providing a Q-switch comprising a first pyroelectric crystal having opposing end faces disposed along a first pyroelectric axis and providing a second pyroelectric crystal having opposing end faces disposed along a second pyroelectric axis. The method further comprises configuring the second pyroelectric crystal to provide pyroelectric charge from the opposing end faces of the second pyroelectric crystal to neutralize pyroelectric charge on opposing end faces of the first pyroelectric crystal.

### BRIEF DESCRIPTION OF THE DRAWINGS

FIG. 1 illustrates a perspective view of an optical modulator in accordance with an aspect of the present invention.

FIG. 2 illustrates a plan view of the optical modulator of FIG. 1 in accordance with an aspect of the present invention.

FIG. 3 illustrates a cross-sectional view of the optical modulator of FIG. 1 taken along the lines A-A in accordance with an aspect of the present invention.

FIG. 4 illustrates a schematic block diagram of a laser system in accordance with another aspect of the present invention.

FIG. 5 illustrates a methodology for providing an optical modulator in accordance with an aspect of the present invention.

### DETAILED DESCRIPTION

An optical modulator is provided that includes a Q-switch formed of a first pyroelectric crystal and a charge dissipating device formed of a second pyroelectric crystal that is cut and oriented with its pyroelectric axis orthogonal (e.g., 90°) relative to the first pyroelectric crystal. For example, the second pyroelectric crystal can be cut and oriented with its pyroelectric axis and opposing end faces in the y-direction relative to the first pyroeletric crystal that is cut and oriented with its pyroelectric axis and opposing end faces in the z-direction. The second pyroelectric crystal is configured and oriented in a manner to provide pyroelectric charge near the opposing end faces of the first pyroelectric crystal to counterbalance the pyroelectric charge produced on the opposing end faces of the first pyroelectric crystal. Pryroelectric charge is the surface charge buildup on a pyroelectric crystal due to the pyroelectric effect.

In one aspect of the invention, the charge dissipating device includes conductive surfaces disposed on the opposing end faces of the second pyroelectric crystal and conductors that extend from opposing ends of each of the conductive surfaces of the opposing end faces of the second pyroelectric crystal. The conductors are configured to extend orthogonal (e.g., 90°) to the second pyroelectric axis (e.g., the x-direction) near opposing end faces of the first pyroelectric crystal. The conductors are employed to concentrate the pyroelectric field and pyroelectric charge of the second pyroelectric crystal in order to ionize the air in the proximity of the faces of the first pyroelectric crystal. The ionized air serves as a source of free charge (positively charged ions and negatively charged electrons) that the pyroelectric field of the first pyroelectric crystal can attract to the dielectric faces of the first pyroelectric crystal to neutralize the bound charge induced by the pyroelectric effect of the first pyroelectric crystal. Neutralization of the bound charge of the first pyroelectric crystal mitigates preleasing and holdoff problems when the first pyroelectric crystal is employed in a Q-switch optical modulator of a laser system.

The second pyroelectric crystal serves to generate enough ions in the surrounding air to neutralize the pyroelectric field of the first pyroelectric crystal despite significant shifts in system operating temperature. Furthermore, the second pyroelectrical crystal is a passive device and does not require electrical or mechanical power to produce the desired ions. Furthermore, the optical modulator of the present invention provides for a compact, passive Q-switch package that is similar in size and price to a radioactive source solution without the deleterious effects of employing radioactive materials.

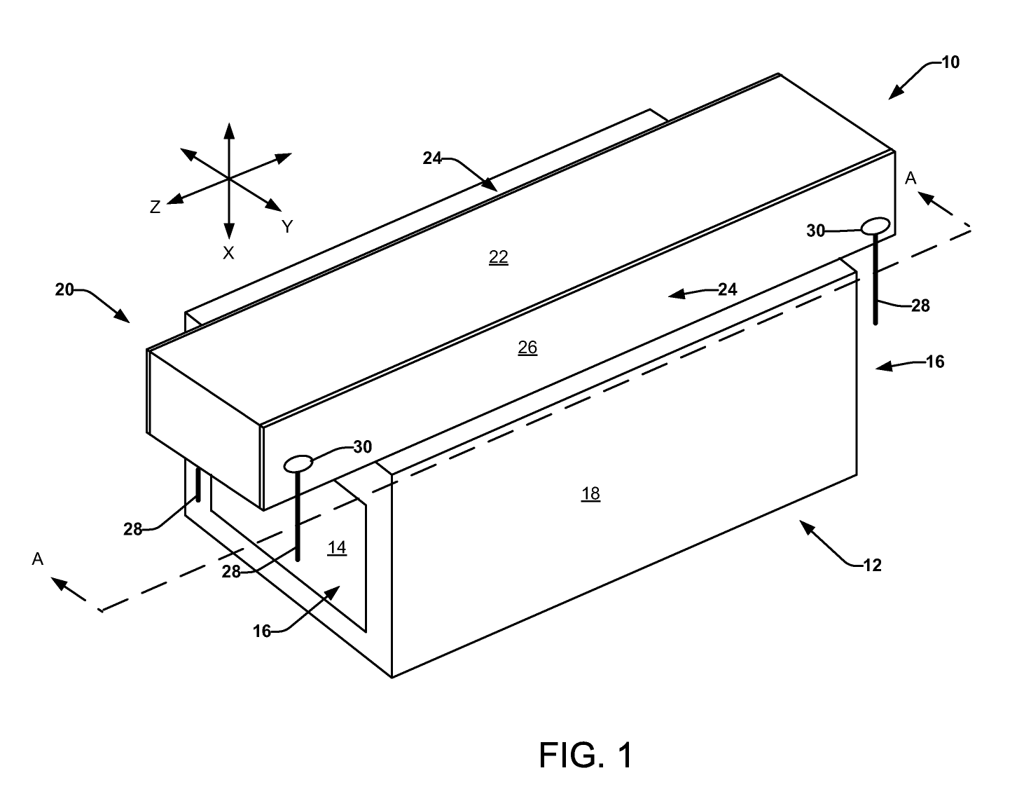

FIG. 1 illustrates a perspective view of an optical modulator 10 in accordance with an aspect of the present invention. The optical modulator 10 comprises a Q-switch 12 formed of a first pyroelectric crystal 14 shaped into a block that is fastened into an electrically insulated housing 18. The first pyroelectric crystal 14 is cut to have opposing end faces 16 configured to pass radiation from a laser along a propagation path that is the same as a first pyroelectric axis (e.g., z-direction) of the first pyroelectric crystal 14. Static pyroelectric charge builds up on the end faces 16 due to the pyroelectric effect. The amount and polarity of charge on each opposing end face 16 depends on the amount of increase or decrease in the system temperature, such that the charge build up on opposing end faces is of opposite polarity to one another. The first pyroelectric crystal 14 may be formed of Lithium Niobate (LiNbO₃), which has a pyroelectric coefficient of −83 μC/m²/K. Alternatively, the first pyroelectric crystal may be formed of Lithium tantalate (LiTaO₃) with a pyroelectric coefficient of −176 μC/m²/K or barium borate (BBO) with a pyroelectric coefficient of −14.5 μC/m²/K, such that the charge induced per unit area per unit temperature change increases with a decrease in the pyroelectric coefficient. Other pyroelectric electro-optical material may be employed to form the Q-switch 12, such as other tantalates, Rubidium Titanyle Phosphate (RTP) (RbTiOPO₄) and other titanyl phosphates.

The optical modulator 10 further comprises a charge dissipating device 20 disposed adjacent the Q-switch 12. The charge dissipation device 20 is formed of a second pyroelectric crystal 22 that is cut and oriented with a second pyroelectric axis and opposing end faces 24 orthogonal (e.g., y-direction) to the first pyroelectric axis of the first pyroelectric crystal 14. The opposing end faces 24 of the second pyroelectric crystal 22 are conductively plated to form conductive end surfaces 26. The conductive plating can be gold or some other suitable plating material. The charge dissipating device 20 further comprises a set of four conductors 28 configured to extend orthogonal (e.g., x-direction) to the second pyroelectric axis to provide conductors from both opposing end faces 24 of the second pyroelectric conductor 22 in proximity of each opposing end face 16 of the first pyroelectric crystal 14, such that pryoelectric charge of both positive and negative polarity from the second pyroelectric crystal are provided in proximity of each opposing end face of the first pyroelectric crystal. The conductors 28 concentrate the field strength of the conductive end surfaces of the opposing end faces 24 of the second pyroelectric crystal 22 at tips of the conductors 28 in order to concentrate a coronal discharge about the opposing end faces 16 of the first pyroelectric crystal 14.

Each conductor 28 can be formed of gold plated tungsten needles, which represents a conductively-plated system that can attain extremely small point dimensions, but other alternatives to tungsten and gold may be employed. A given conductor is bonded on each end of the conductive surface of each opposing face of the second pyroelectric crystal. It is to be appreciated that a given conductor can be replaced by a plurality of conductors disposed at each end of the opposing end faces of the second pyroelectric crystal. The conductors 28 can be bonded to the conductive end surfaces, for example, by a conductive epoxy 30. Other mechanisms to conductively bond the conductors 28 to the conductive ends surfaces 26 of the opposing end faces 24 of the second pyroelectric crystal 22 can be employed, such as a low temperature solder or other method that does not subject the conductive end surfaces 26 to highly localized heat.

It is to be appreciated that the charge dissipating device 20 can be oriented and configured in a variety of different ways as long as pryoelectric charge of both positive and negative polarity from the second pyroelectric crystal are provided in proximity of each opposing end face of the first pyroelectric crystal.

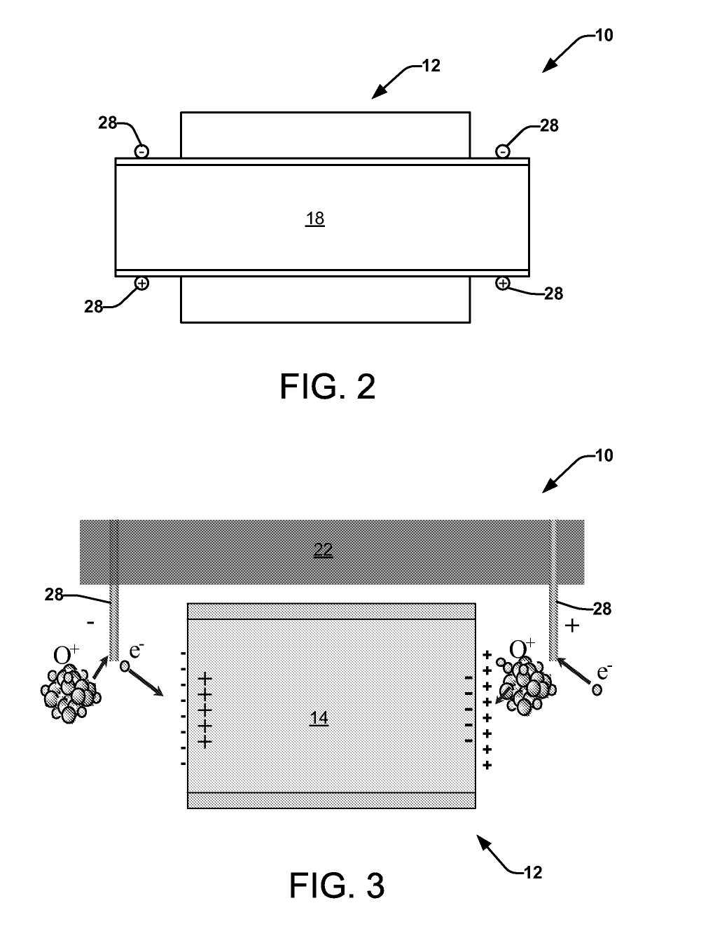

FIG. 2 illustrates a top view of the optical modulator 10 of FIG. 1. As illustrated in FIG. 2, a conductor 28 is disposed at each end of both opposing end faces 24 of the second pyroelectric crystal 22, such that conductors of oppositely charged polarities are provided at both opposing end faces 16 of first pyroelectric crystal 14. The oppositely charged conductors 28 can provide both positively charged ions and negatively charged electrons at each opposing end face 16 of the first pyroelectric crystal 14. Therefore, it does not matter which of the opposing end faces of the first or second pyroelectric crystals 14 and 22 are positively charged and which of the opposing end faces of the first and second pyroelectric crystals 14 and 22 are negatively charged since the charge dissipating device 20 provides charges of both polarities at both opposing end faces 16 of the first pyroelectric crystal 14.

FIG. 3 illustrates a cross-sectional view of the optical modulator of FIG. 1 along the lines A-A. As illustrated in FIG. 3, the conductors 28 concentrate the pyroelectric field and pyroelectric charge of the second pyroelectric crystal 22 at end points of the conductors 28 in order to ionize the air in the proximity of the opposing end faces 16 of the first pyroelectric crystal 14. The ionized air serves as a source of free charge that the pyroelectric field at the opposing end faces 1 6 of the first pyroelectric crystal 14 can attract to its end face surfaces to neutralize the bound charge induced by the pyroelectric effect of the first pyroelectric crystal 14. The ionization only occurs when the ambient temperature changes since both the first and second pyroelectric crystals 14 and 22 are pyroelectric. As illustrated in FIG. 3, the negatively charged electrons are attracted to the end face being positively charged and the positively charged ions are attracted to the end face being negatively charged.

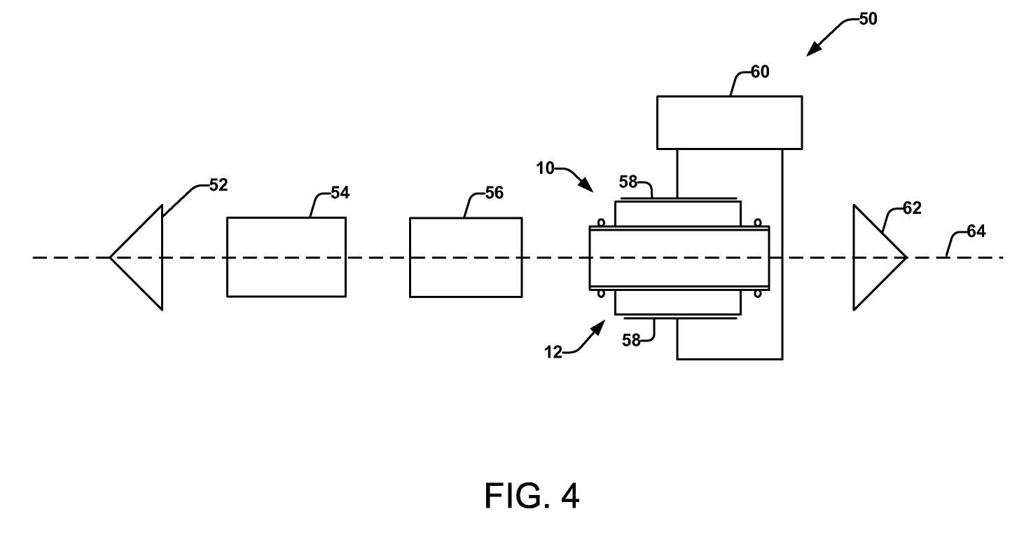

FIG. 4 illustrates a laser system 50 in accordance with an aspect of the present invention. The laser system 50 of FIG. 4 employs the optical modulator 10 of FIGS. 1-3. The laser system 50 can be employed in a laser range finder, a laser designator or a variety of other laser applications. The laser system 50 includes a laser rod 54 whose axial stimulated emission passes through both the aperture of the Q-switch 12 of the optical modulator 10, as well as a polarizer 56. The laser system 50 also includes two prisms 52 and 62 that define the optical cavity of the laser system 50. The Q-switch 12 of the optical modulator 10 is provided with two electrodes 58 connected to a modulating power supply 60. The optical components are arranged on an optical axis 64, with the electrodes 58 being arranged adjacent opposite ends of the first pyroelectric crystal of the Q-switch 12 on opposite sides of the optical axis 64. The optical axis 64 is also the propagation path of the laser light from the laser pump and Q-switch in addition to being along the same direction as the pyroelectric axis of the first pyroelectric crystal.

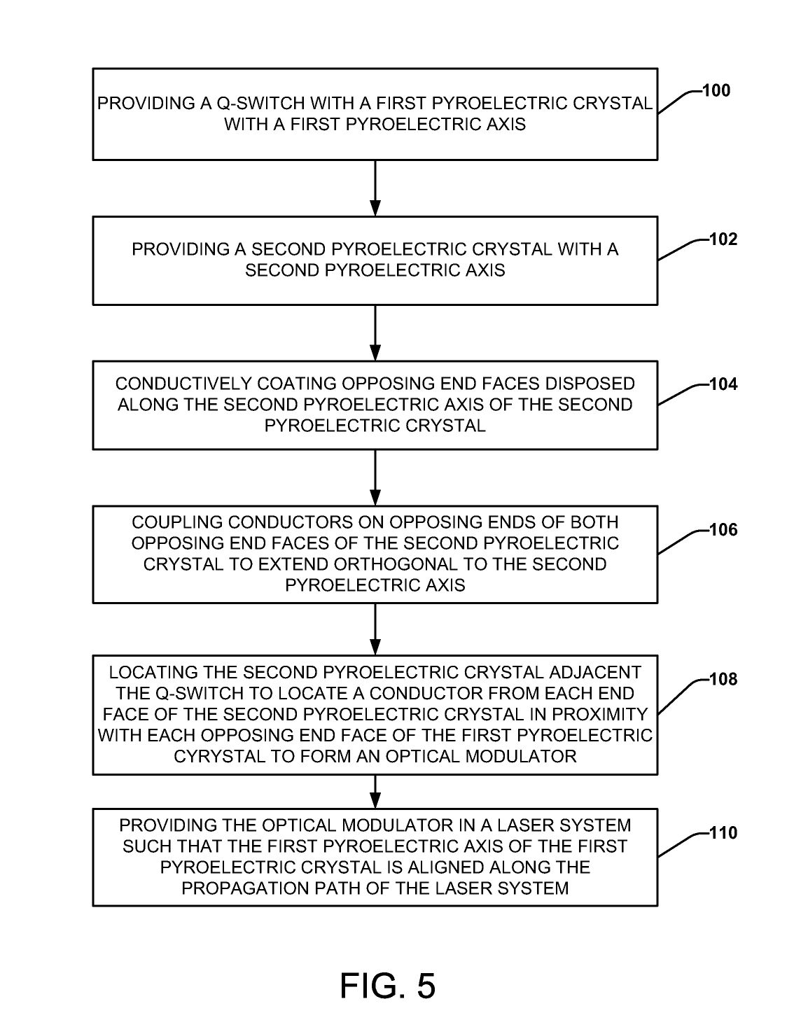

In view of the foregoing structural and functional features described above, a methodology in accordance with various aspects of the present invention will be better appreciated with reference to FIG. 5. While, for purposes of simplicity of explanation, the methodologies of FIG. 5 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 5 illustrates a methodology for providing an optical modulator in accordance with an aspect of the present invention. The methodology begins at 100 where a Q-switch is provided having a first pyroelectric crystal with a first pyroelectric axis. At 102, a second pyroelectric crystal is provided with a second pyroelectric axis. At 104, opposing end faces of the second pyroelectric crystal disposed along the second pyroelectric axis are conductively coated to provide conductive end surfaces. At 106, conductors are coupled to opposing ends of both opposing end faces of the second pyroelectric crystal and are configured to extend orthogonal to the second pyroelectric axis. At 108, the second pyroelectric crystal is located adjacent the Q-switch to locate a conductor from each end face of the second pyroelectric crystal in proximity with each opposing end face of the first pyroelectric crystal to form an optical modulator, such that pryoelectric charge of both positive and negative polarity from the second pyroelectric crystal are provided in proximity of each opposing end face of the first pyroelectric crystal. Furthermore, the first pyroelectric axis of the first pyroelectric crystal is aligned orthogonal to the second pyroelectric axis of the second pyroelectric crystal. At 110, the optical modulator is provided in a laser system, such that the first pyroelectric axis of the first pyroelectric crystal is aligned along the propagation path of the laser system.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the scope of the appended claims.

Having described the invention, the following is claimed:

1. An optical modulator comprising:
a Q-switch comprising a first pyroelectric crystal having opposing end faces disposed along a first pyroelectric axis; and
a charge dissipating device comprising a second pyroelectric crystal having opposing end faces disposed along a second pyroelectric axis, the charge dissipating device being configured to provide pyroelectric charge from the opposing end faces of the second pyroelectric crystal to neutralize pyroelectric charge on opposing end faces of the first pyroelectric crystal.

2. The optical modulator of claim 1, wherein the second pyroelectric crystal is oriented adjacent to the first pyroelectric crystal such that the second pyroelectric axis is orthogonal to the first pyroelectric axis.

3. The optical modulator of claim 1, wherein the opposing end faces of the second pyroelectric crystal have conductive surfaces and the charge dissipating device further comprises a conductor that extends from each end of each opposing end face of the second pyroelectric crystal.

4. The optical modulator of claim 3, wherein a conductor from each end face of the second pyroelectric crystal extends in proximity of each end face of the first pyroelectric crystal, such that pryoelectric charge of both positive and negative polarity from the second pyroelectric crystal are provided in proximity of each opposing end face of the first pyroelectric crystal.

5. The optical modulator of claim 3, wherein each conductor is formed from a tungsten needle coated with gold.

6. The optical modulator of claim 3, wherein the conductive surfaces are a gold coating.

7. The optical modulator of claim 3, wherein each conductor is bonded to one of the conductive surfaces employing a conductive epoxy.

8. The optical modulator of claim 1, wherein the first pyroelectric crystal comprises one of lithium niobate (LiNbO₃), a barium borate (BBO), lithium tantalate (LiTaO₃), and rubidium titanyle phosphate (RTP) (RbTiOPO₄).

9. The optical modulator of claim 1, wherein the second pyroelectric crystal comprises one of lithium niobate (LiNbO₃), a barium borate (BBO), lithium tantalate (LiTaO₃), and rubidium titanyle phosphate (RTP) (RbTiOPO₄).

10. A laser system comprising the optical modulator of claim 1.

11. An optical modulator comprising:
a Q-switch comprising a first pyroelectric crystal having opposing end faces disposed along a first pyroelectric axis; and
a second pyroelectric crystal having opposing end faces with conductive surfaces disposed along a second pyroelectric axis that is orthogonal to the first pyroelectric axis; and
conductors extending from conductive surfaces of each end of each opposing end face of the second pyroelectric crystal in proximity of each end face of the first pyroelectric crystal, such that pryoelectric charge of both positive and negative polarity from the second pyroelectric crystal are provided in proximity of each opposing end face of the first pyroelectric crystal.

12. The optical modulator of claim 11, wherein each conductor is formed from a tungsten needle coated with gold.

13. The optical modulator of claim 11, wherein the conductive surfaces are a gold coating.

14. The optical modulator of claim 3, wherein each conductor is bonded to one of the conductive surfaces employing a conductive epoxy.

15. The optical modulator of claim 1, wherein the first pyroelectric crystal comprises lithium niobate (LiNbO₃) and the second pyroelectric crystal comprises lithium tantalate (LiTaO₃).

16. A laser system comprising the optical modulator of claim 11.

17. A method of providing optical modulator, the method comprising:
providing a Q-switch comprising a first pyroelectric crystal having opposing end faces disposed along a first pyroelectric axis;
providing a second pyroelectric crystal having opposing end faces disposed along a second pyroelectric axis; and
configuring the second pyroelectric crystal to provide pyroelectric charge from the opposing end faces of the second pyroelectric crystal to neutralize pyroelectric charge on opposing end faces of the first pyroelectric crystal.

18. The method of claim 17, further comprising:
conductively coating the opposing end faces of the second pyroelectric crystal;
conductively coupling conductors to opposing end faces of the second pyroelectric crystal to extend orthogonal to the second pyroelectric axis; and
locating the second pyroelectric crystal adjacent the Q-switch to locate a conductor from each opposing end face of the second pyroelectric crystal in proximity with each opposing end face of the first pyroelectric crystal, such that pryoelectric charge of both positive and negative polarity from the second pyroelectric crystal are provided in proximity of each opposing end face of the first pyroelectric crystal.

19. The method of claim 17, wherein the first pyroelectric crystal comprises lithium niobate (LiNbO₃) and the second pyroelectric crystal comprises lithium tantalate (LiTaO₃).

20. The method of claim 17, further comprising providing the optical modulator in a laser system such that the first pyroelectric axis is aligned along the propagation path of the laser system.
